(19) United States
(12) Patent Application Publication
(10) Pub. No.: US 2009/0099771 A1
(43) Pub. Date: Apr. 16, 2009

(54) Method and System for Providing Awareness of a Vehicle's Location and Heading

(76) Inventor: Patrick Wipplinger, Moerfelden-Walldorf (DE)

Correspondence Address: MOORE AND VAN ALLEN PLLC FOR BOEING, 430 DAVIS DRIVE, SUITE 500, MORRISVILLE, NC, 27560, US

(21) Appl. No.: 11/871,439

(22) Filed: Oct. 12, 2007

(51) Int. Cl. G01C 21/30

(52) U.S. Cl. 701/209; 701/208; 701/213

(57) ABSTRACT

A method for providing awareness of a vehicle's location and heading may include determining a geographic location and heading of the vehicle and presenting a map corresponding to a geographical area where the vehicle is located. The method may also include presenting a predetermined symbol on the map representing the vehicle. The predetermined symbol defines a unique shape to provide substantially unambiguous awareness to an operator of a location of the vehicle and a heading of the vehicle. The predetermined symbol may include a symmetrical body symmetrical about the heading of the vehicle and including a predetermined length and width.

### BACKGROUND OF THE INVENTION

The present invention relates to controlling operation and maneuvering of a vehicle, and more particularly to a method and system for presenting a representation of an actual vehicle on an electronically displayed movable map to provide awareness of the vehicle's location and heading to an operator.

Airports, particularly those serving large metropolitan areas or that serve as hubs for providing flight service to other regional airports, can be complex including numerous runways, taxiways, terminals, and gates, hangars and other facilities to which a aircraft may taxi. Navigating an aircraft from one desired location, such as a runway to a particular gate at a designated terminal at such a complex airport can significantly increase a pilot's workload and level of stress. Typically, a pilot follows radio instructions from an air traffic control (ATC) ground controller and uses paper charts of the airport to orient landmarks or features represented on the paper chart with the actual landmark or feature visible outside of the aircraft. However, the features or landmarks may not always be that visible or their interpretation may be unclear. This can lead to confusion and/or a lack of awareness of a location of the aircraft and a desired heading or direction of travel of the aircraft to reach a desired destination on the airport.

### BRIEF SUMMARY OF THE INVENTION

In accordance with an embodiment of the present invention, a method for providing awareness of a vehicle's location and heading may include determining a geographic location and heading of the vehicle and presenting a map corresponding to a geographical area where the vehicle is located. The method may also include presenting a predetermined symbol on the map representing the vehicle. The predetermined symbol defines a unique shape to provide substantially unambiguous awareness to an operator of a location of the vehicle and a heading of the vehicle. The predetermined symbol may include a symmetrical body symmetrical about the heading of the vehicle and including a predetermined length and width. The symbol may also include a first vertex on a line of symmetry of the symmetrical body for indicating a front of the vehicle and corresponding to the heading of the vehicle. A second vertex and a third vertex may be positioned on each side of the line of symmetry at a select spacing from one another to define the predetermined width of the symmetrical body. The second and third vertexes may each be a predetermined length rearward from the first vertex to define the predetermined length of the symmetrical body. The symbol may also include a first line segment connecting the first vertex to the second vertex and a second line segment connecting the first vertex to the third vertex. A third line segment perpendicular to the line of symmetry includes first and second end points and a midpoint on the line of symmetry of the symmetrical body. The third line segment is positioned between the first vertex and the second and third vertexes. The third line segment has a length less than the predetermined width of the symmetrical body. A fourth line segment connects between the first end point of the third line segment and the second vertex, and a fifth line segment connects between the second end point of the third line segment and the third vertex.

In accordance with another embodiment of the present invention, a system for providing awareness of a vehicle's location and heading may include a display to present a map corresponding to a geographical area where the vehicle is located and to present a predetermined symbol representing the vehicle on the map. The predetermined symbol may define a unique shape to provide substantially unambiguous awareness to an operator of a location of the vehicle and a heading of the vehicle. The predetermined symbol may include a symmetrical body symmetrical about the heading of the vehicle and including a predetermined length and width. A first vertex on a line of symmetry of the symmetrical body indicates a front of the vehicle and corresponds to the heading of the vehicle. A second vertex and a third vertex are provided on each side of the line of symmetry at a select spacing from one another to define the predetermined width of the symmetrical body. Each of the second and third vertexes is a predetermined length rearward from the first vertex to define the predetermined length of the symmetrical body. A first line segment connects the first vertex to the second vertex and a second line segment connects the first vertex to the third vertex. A third line segment of the symmetrical body of the symbol is perpendicular to the line of symmetry and includes first and second end points and a midpoint on the line of symmetry of the symmetrical body. The third line segment is positioned between the first vertex and the second and third vertexes. The third line segment has a length less than the predetermined width of the symmetrical body. A fourth line segment is connected between the first end point of the third line segment and the second vertex, and a fifth line segment is connected between the second end point of the third line segment and the third vertex.

In accordance with another embodiment of the present invention, an aircraft includes a fuselage and wings attached to the fuselage. The aircraft also includes a cockpit in the fuselage. A display is mounted in the cockpit to present a map corresponding to an airport where the aircraft is located and to present a predetermined symbol representing the aircraft on the map. The predetermined symbol defines a unique shape to provide substantially unambiguous awareness to a pilot of a location of the aircraft and a heading of the aircraft. The unique shape of the predetermined symbol may be similar to that previously described.

In accordance with another embodiment of the present invention, a computer program product for providing awareness of a vehicle's location and heading includes a computer usable medium having computer usable program code embodied therewith. The computer usable program code may be configured to process geographic location and heading data of the vehicle. The computer usable program code may also be configured to present a map corresponding to a geographical area where the vehicle is located based on the geographical location data. The computer usable program code may also be configured to present a predetermined symbol representing the vehicle on the map, wherein the predetermined symbol defines a unique shape to provide substantially unambiguous awareness to an operator of a location of the vehicle and a heading of the vehicle. The computer usable program code may include code configured to present the predetermined symbol as a symmetrical body symmetrical about the heading of the vehicle and including a predetermined length and width. The computer usable program code is also configured to present a first vertex on a line of symmetry of the symmetrical body for indicating a front of the vehicle and corresponding to the heading of the vehicle. The computer usable program code is also configured to present a second vertex and a third vertex on each side of the line of symmetry at a select spacing from one another to define the predetermined width of the symmetrical body. The second and third vertexes are also each a predetermined length rearward of the first vertex to define the predetermined length of the symmetrical body. The computer usable program code is also configured to present a first line segment connecting the first vertex to the second vertex and to present a second line segment connecting the first vertex to the third vertex. The computer usable program code is also configured to present a third line segment perpendicular to the line of symmetry and including first and second end points and a midpoint on the line of symmetry of the symmetrical body. The third line segment is positioned between the first vertex and the second and third vertexes. The third line segment also has a length less than the predetermined width of the symmetrical body. The computer usable program code is further configured to present a fourth line segment connected between the first end point of the third line segment and the second vertex and to present a fifth line segment connected between the second end point of the third line segment and the third vertex.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is an illustration of an aircraft including a system and method for representing the aircraft on a moving map in accordance with an embodiment of the present invention.

FIG. 2 is a block schematic diagram of an example of a system for representing a vehicle on a moving map in accordance with an embodiment of the present invention.

FIG. 3 is an illustration of an example of a graphical user interface for presenting a moving map and a representation of an aircraft on the moving map in accordance with an embodiment of the present invention.

FIG. 4 is a detailed view of a symbol to represent an aircraft on a moving map in accordance with an embodiment of the present invention.

FIG. 5 is a flow chart of an example of a method for representing a vehicle on a moving map in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, portions of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “unit,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage devices; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

While the embodiments of the present invention may be described with reference to application to an aircraft and providing awareness of a geographic location and heading of an aircraft on an airport, the embodiments of the present invention may also be applicable to other vehicles, such as ships or watercraft, terrestrial vehicles or others.

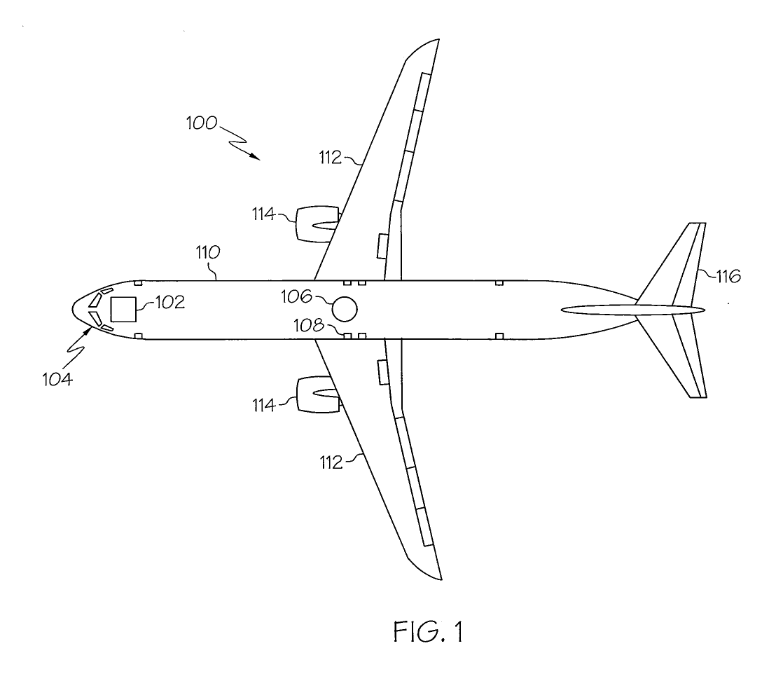

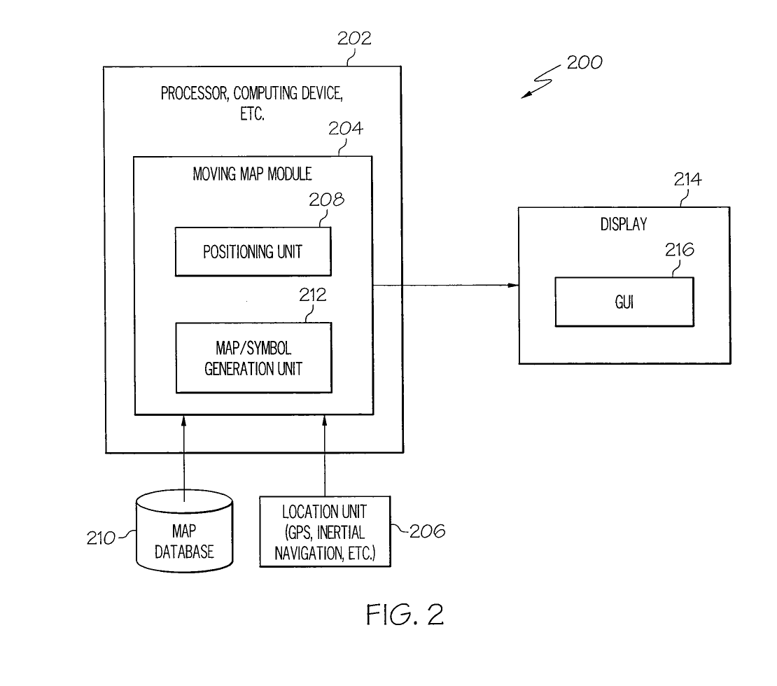

FIG. 1 is an illustration of an aircraft 100 including a system 102 for representing the aircraft 100 on a moving map in accordance with an embodiment of the present invention. A moving map is a module or computer application that may present an electronic representation of a particular airport on a display in a cockpit of an aircraft, such as aircraft 100. The moving map may help a pilot or flight crew member identify and orient the position of the aircraft 100 on the ground in relation to runways, taxiways, terminals and other airport structures and landmarks or features. The moving map may allow the pilot or flight crew member to identify the position of the aircraft in relation to these other airport objects without reference to paper charts or as a further aid, supplement or confirmation to the paper charts or vice versa. An example of a moving map module or application is Jeppesen Moving Airport Map, which is available from Jeppesen, Sanderson, Inc., of Englewood, Colo. Jeppesen Moving Airport Map is a trademark of jeppesen, Sanderson, Inc., in the United States, other countries or both. This moving map application may also provide position of an aircraft in flight as well as on the ground. As will be described in more detail with reference to FIG. 2, the system 102 may include a map database containing electronic data for presenting detailed maps electronically on a display (not shown in FIG. 1) in a cockpit 104 of the aircraft 100.

The system 102 may also include a location system 106 or unit to provide data for determining a geographic location and heading or direction of travel of the aircraft. The location system 106 may include a global positioning satellite (GPS) system, inertial navigation system or similar system, magnetic or gyrocompass or similar system for determining a geographic location and heading or direction of travel of the aircraft 100. The location system 106 or geographic location features of the location system 106 may be positioned proximate to the main landing gear 108 of the aircraft 100 so as to provide a more precise measurement of the geographic location of the aircraft.

The aircraft 100 also include a fuselage 110, wings 112 attached to the fuselage 110 and engines 114 mounted to the wings 112 for propulsion. The aircraft 100 additionally includes a tail section 116. The wings 112 and tail section 116 include control surface for controlling flight of the aircraft, such as an attitude of the aircraft in flight, altitude of the aircraft, direction of flight and the like.

FIG. 2 is a block schematic diagram of an example of a system 200 for representing a vehicle on a moving map or similar electronic map system in accordance with an embodiment of the present invention. The system 200 may be used for the system 102 in FIG. 1. The system 200 may also be applicable to other vehicles besides aircraft, such as ships or watercraft navigating in a harbor or other close body of water, or terrestrial vehicles.

The system 200 may include a processor 202, computing device or similar device. A moving map module 204 or similar module or application may be operable on the processor 202. The moving map module 204 may receive geographic location data from a location unit 206. The location unit 206 may include a GPS, inertial navigation system, compass and/or other systems or equipment to determine a geographic location and heading of the vehicle associated with the system 200.

A positioning unit 208 associated with the moving map module 204 may determine the geographic location and heading of the vehicle from the geographic location data. A map data corresponding to a geographical area where the vehicle is located may be retrieved from a map database 210. For example if the vehicle is an aircraft, the map data retrieved from the map database 210 may be for the particular airport where the aircraft has landed. Accordingly, the map database 210 may store electronic data to generate detailed maps of different airports where an aircraft may land.

The moving map module 204 may also include a map/symbol generation unit 212. The map/symbol generation unit 212 may receive the electronic map data from the map database 210 and generate a detailed map of the geographic area when the vehicle is located or airport where the aircraft is located. The detailed map may be presented electronically to the pilot or flight crew member on a display in the cockpit, such as display 214 in FIG. 2.

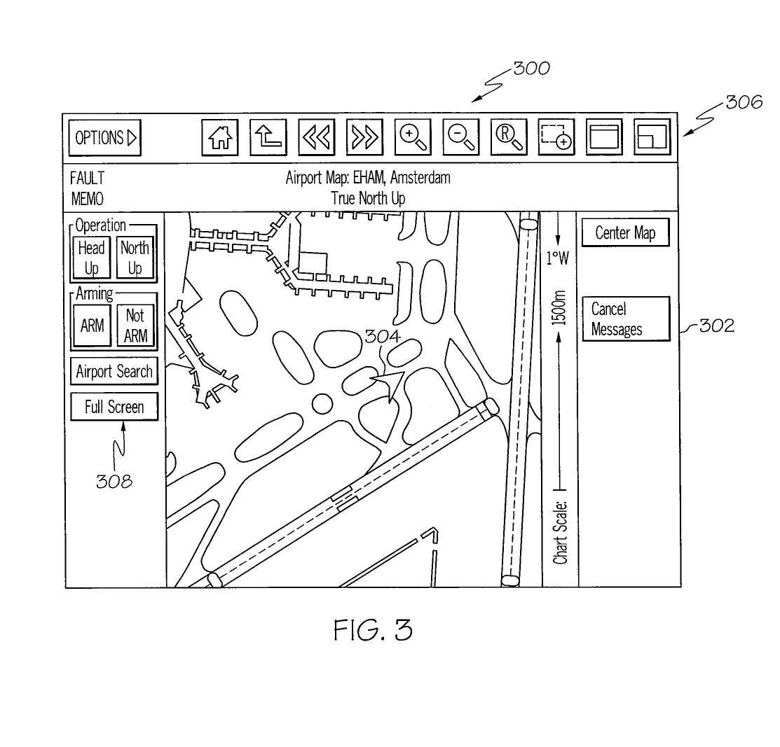

The map/symbol generation unit 212 may also generate a predetermined symbol representing the vehicle or aircraft for presentation on the map on the display 214. The predetermined symbol preferably defines a unique shape and stands out from the map to provide substantially unambiguous awareness to an operator, pilot or crew member of a location of the vehicle and heading of the vehicle. An example of a map and predetermined symbol will be described with reference to FIG. 3. The map and predetermined symbol may be presented on the display 214 as an interactive graphical user interface 216 (GUI).

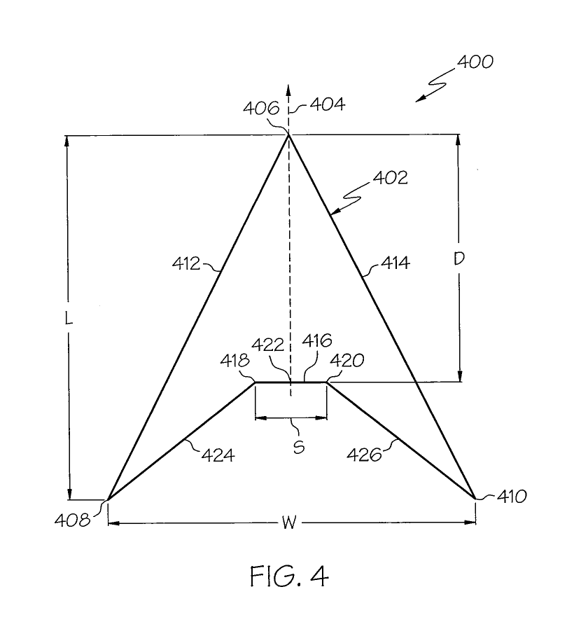

FIG. 3 is an illustration of an example of a graphical user interface (GUI) 300 for presenting a moving map 302 and a representation of a vehicle on the moving map 302 in accordance with an embodiment of the present invention. In the example of FIG. 3, the moving map 302 is an airport and the vehicle is an aircraft. As illustrated in FIG. 3, the representation of the vehicle or aircraft is a predetermined symbol 304 that defines a unique shape and is distinguishable from the map background by color and/or other distinguishing characteristics to provide substantially unambiguous awareness to the pilot or crew of a location of the aircraft on the airport and heading of the aircraft. The unique shape of the symbol 304 will be described with reference to FIG. 4.

The GUI 300 may also include interactive controls 306 and 308 to permit a pilot or crew member to control operation of the positional awareness system, such as the system 200 in FIG. 1, and to control presentation of the moving map 302 and the predetermined symbol 304 on the map.

FIG. 4 is a detailed view of a symbol 400 to represent an aircraft on a moving map in accordance with an embodiment of the present invention. The symbol 400 may also be used to represent other vehicles in other applications as previously discussed. The symbol 400 may be used for the symbol 304 in FIG. 3. The symbol 400 includes a symmetrical body 402 symmetrical about a heading or direction of travel of the vehicle as represented by the broken or dashed arrow 404 in FIG. 4. The broken or dashed arrow 404 is not necessarily part of the symbol 400 as displayed on a moving map and is shown in FIG. 4 to illustrate the symmetry of the symbol 400 and to facilitate describing the structure or shape of the symbol 400. The symmetrical body 402 has a predetermined length “L” and width “W”. In accordance with an embodiment of the present invention, the predetermined length L and width W may be equal.

The symbol 400 or symmetrical body 402 may include a first vertex 406 on the line of symmetry 404, the first vertex 406 indicates a front of the vehicle or nose of the aircraft and corresponds to the heading of the aircraft or vehicle. A second vertex 408 and a third vertex 410 may be disposed on each side of the line of symmetry 404 at a selected spacing from one another to define the predetermined width of the symmetrical body 402. The second and third vertex 408 and 410 are also positioned a predetermined length rearward or toward the back of the symbol 400 representing the aircraft or vehicle. In accordance with an embodiment of the present invention, the length from the first vertex 406 to each of the second and third vertexes 408 and 410 define the predetermined length L of the symmetrical body 402. A first line segment 412 connects the first vertex 406 to the second vertex 408 and a second line segment 414 connects the first vertex 406 to the third vertex 410.

A third line segment 416 lies perpendicular to the line of symmetry 404 and includes a first endpoint 418 and a second endpoint 420. A midpoint 422 of the third line segment 416 lies on the line of symmetry 404. The line segment 416 is positioned between the first vertex 406 and the second and third vertexes 408 and 410 at a selected distance “D” from the first vertex 406. The third line segment 416 also has a chosen length “S” which is less than the predetermined width W. In accordance with an embodiment of the present invention, the predetermined length L and width W may be equal, the distance D may be ⅔ the length L and width W and the chosen length S may be 2/10 the length L and the width W.

A fourth line segment 424 connects the first end point 418 of the third line segment 416 to the second vertex 408. A fifth line segment 426 connects the second end point 420 of the third line segment 416 to the third vertex 410.

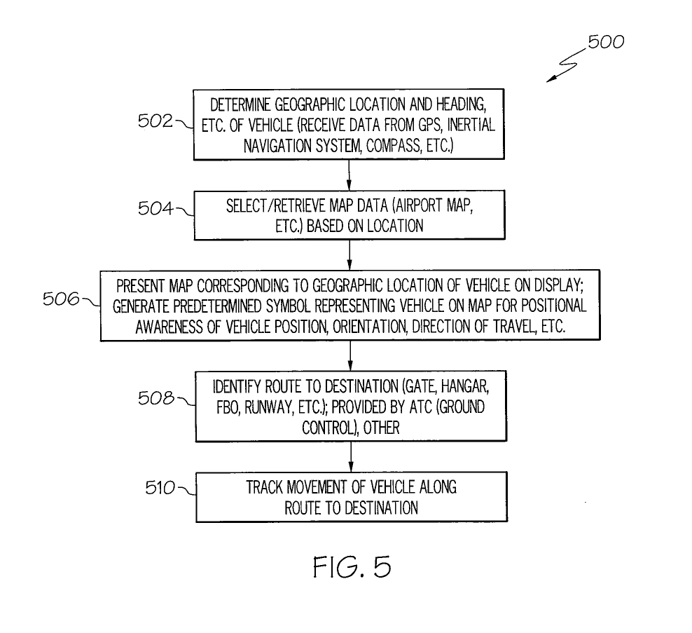

FIG. 5 is a flow chart of an example of a method 500 for representing a vehicle on a moving map in accordance with an embodiment of the present invention. The method 500 may be embodied in and performed by the system 102 in FIG. 1 and the system 200 in FIG. 2, and may present the GUI 300 in FIG. 3 and the unique symbol 400 of FIG. 4.

In block 502, a geographic location, heading and other navigational information related to the vehicle may be determined. Geographic location and heading data may be received or measured by a GPS, inertial navigation system, compass or other navigational or positioning equipment.

In block 504, map data may be selected or retrieved from a database based on the geographic location data. The map data may be for a particular airport where the aircraft is located or for a particular harbor or body of water where a ship or other watercraft may be located.

In block 506, a map corresponding to the geographic location of vehicle may be presented in a display. Also in block 506 a predetermined symbol representing the vehicle may be presented on the map for positional awareness of the vehicle's geographic location, orientation, heading or direction of travel. As previously discussed, the predetermined symbol may be substantially similar to the symbol illustrated in FIG. 4.

In block 508, a route to a destination may be identified and presented on the map in the display. The destination may be to a particular terminal or gate at a terminal, hangar, fixed base operation (FBO), fueling station, deicing equipment or the like. The route may include a series of taxiways and cross one or more runways. The route may be provided by ATC ground control directly to the system or by someone else.

In block 510, movement of the vehicle along the route to the destination may be tracked by movement of the symbol representing the vehicle on the map in the display. Turn-by-turn instructions may be provided by ATC ground control and the vehicle positional or location awareness system and method may be used to supplement and/or confirm ATC instructions.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for providing awareness of a vehicle's location and heading, the method comprising:
determining a geographic location and heading of the vehicle;
presenting a map corresponding to a geographical area where the vehicle is located;
presenting a predetermined symbol representing the vehicle on the map, wherein the predetermined symbol defines a unique shape to provide substantially unambiguous awareness to an operator of a location of the vehicle and a heading of the vehicle, and wherein presenting the predetermined symbol on the map comprises:
presenting a symmetrical body symmetrical about the heading of the vehicle and including a predetermined length and width;
presenting a first vertex on a line of symmetry of the symmetrical body for indicating a front of the vehicle and corresponding to the heading of the vehicle;
presenting a second vertex and a third vertex on each side of the line of symmetry at a select spacing from one another to define the predetermined width of the symmetrical body and each a predetermined length rearward from the first vertex to define the predetermined length of the symmetrical body;
presenting a first line segment connecting the first vertex to the second vertex;
presenting a second line segment connecting the first vertex to the third vertex;
presenting a third line segment perpendicular to the line of symmetry and including first and second end points and a midpoint on the line of symmetry of the symmetrical body, wherein the third line segment is positioned between the first vertex and the second and third vertexes and wherein the third line segment has a length less than the predetermined width of the symmetrical body;
presenting a fourth line segment connected between the first end point of the third line segment and the second vertex; and
presenting a fifth line segment connected between the second end point of the third line segment and the third vertex.

2. The method of claim 1, wherein presenting the predetermined symbol comprises presenting the predetermined length of the symmetrical body equal to the predetermined width.

3. The method of claim 1, wherein presenting the predetermined symbol comprises presenting the third line segment of the symmetrical body at a position about ⅔ of the predetermined length of the symmetrical body from the first vertex.

4. The method of claim 1, wherein presenting the predetermined symbol comprises presenting the third line segment with the length about 2/10 less than the predetermined length of the symmetrical body.

5. The method of claim 1, wherein the vehicle is an aircraft, and wherein presenting a map corresponding to the geographic area where the vehicle is located comprises presenting a map of an airport where the aircraft is located.

6. The method of claim 5, further comprising presenting a route on the map from a current location of the aircraft to a selected location on the airport.

7. The method of claim 1, wherein presenting the predetermined symbol comprises identifying the symbol to provide substantially unambiguous awareness to the operator of the location of the vehicle on the map relative to other features on the map and the heading or direction of travel of the vehicle.

8. The method of claim 1, further comprising tracking movement of the vehicle on the map.

9. The method of claim 1, wherein determining a geographic location and heading of the vehicle comprises at least one of:
receiving data from a global positioning system;
receiving data from an inertial navigation system;
receiving data from a compass.

10. A system for providing awareness of a vehicle's location and heading, the system comprising:
a display to present a map corresponding to a geographical area where the vehicle is located and to present a predetermined symbol representing the vehicle on the map, wherein the predetermined symbol defines a unique shape to provide substantially unambiguous awareness to an operator of a location of the vehicle and a heading of the vehicle, and wherein the predetermined symbol comprises:
a symmetrical body symmetrical about the heading of the vehicle and including a predetermined length and width;
a first vertex on a line of symmetry of the symmetrical body for indicating a front of the vehicle and corresponding to the heading of the vehicle;
a second vertex and a third vertex on each side of the line of symmetry at a select spacing from one another to define the predetermined width of the symmetrical body and each a predetermined length rearward from the first vertex to define the predetermined length of the symmetrical body;
a first line segment connecting the first vertex to the second vertex;
a second line segment connecting the first vertex to the third vertex;
a third line segment perpendicular to the line of symmetry and including first and second end points and a midpoint on the line of symmetry of the symmetrical body, wherein the third line segment is positioned between the first vertex and the second and third vertexes and wherein the third line segment has a length less than the predetermined width of the symmetrical body;
a fourth line segment connected between the first end point of the third line segment and the second vertex; and
a fifth line segment connected between the second end point of the third line segment and the third vertex.

11. The system of claim 10, further comprising a location unit to determine a geographical location and heading of the vehicle.

12. The system of claim 11, further comprising a module to receive and process geographical location and heading data and to present the predetermined symbol on the map in correspondence with the geographical location and heading data.

13. The system of claim 11, wherein the location unit comprises at least one of a system to receive data from a global positioning satellite system, an inertial navigation system, and a compass.

14. An aircraft, comprising:
a fuselage and wings attached to the fuselage;
a cockpit in the fuselage;
a display mounted in the cockpit to present a map corresponding to an airport where the aircraft is located and to present a predetermined symbol representing the aircraft on the map, wherein the predetermined symbol defines a unique shape to provide substantially unambiguous awareness to a pilot of a location of the aircraft and a heading of the aircraft, and wherein the predetermined symbol comprises:
a symmetrical body symmetrical about the heading of the aircraft and including a predetermined length and width;
a first vertex on a line of symmetry of the symmetrical body for indicating a front of the aircraft and corresponding to the heading of the aircraft;
a second vertex and a third vertex on each side of the line of symmetry at a select spacing from one another to define the predetermined width of the symmetrical body and each a predetermined length rearward from the first vertex to define the predetermined length of the symmetrical body;
a first line segment connecting the first vertex to the second vertex;
a second line segment connecting the first vertex to the third vertex;
a third line segment perpendicular to the line of symmetry and including first and second end points and a midpoint on the line of symmetry of the symmetrical body, wherein the third line segment is positioned between the first vertex and the second and third vertexes and wherein the third line segment has a length less than the predetermined width of the symmetrical body;
a fourth line segment connected between the first end point of the third line segment and the second vertex; and
a fifth line segment connected between the second end point of the third line segment and the third vertex.

15. The aircraft of claim 14, further comprising a moving map module to present the map corresponding to the airport.

16. The aircraft of claim 15, further comprising a map database to store a plurality of maps for different airports.

17. The aircraft of claim 14, further comprising a module to receive and process geographical location and heading data and to present the predetermined symbol on the map in correspondence with the geographical location and heading data.

18. A computer program product for providing awareness of a vehicle's location and heading, the computer program product comprising:
a computer usable medium having computer usable program code embodied therewith, the computer usable medium comprising:
computer usable program code configured to process geographic location and heading data of the vehicle;
computer usable program code configured to present a map corresponding to a geographical area where the vehicle is located based on the geographical location data; and
computer usable program code configured to present a predetermined symbol representing the vehicle on the map, wherein the predetermined symbol defines a unique shape to provide substantially unambiguous awareness to an operator of a location of the vehicle and a heading of the vehicle, and wherein the computer usable program code configured to present the predetermined symbol comprises:
computer usable program code configured to present a symmetrical body symmetrical about the heading of the vehicle and including a predetermined length and width;
computer usable program code configured to present a first vertex on a line of symmetry of the symmetrical body for indicating a front of the vehicle and corresponding to the heading of the vehicle;
computer usable program code configured to present a second vertex and a third vertex on each side of the line of symmetry at a select spacing from one another to define the predetermined width of the symmetrical body and each a predetermined length rearward of the first vertex to define the predetermined length of the symmetrical body;
computer usable program code configured to present a first line segment connecting the first vertex to the second vertex;
computer usable program code configured to present a second line segment connecting the first vertex to the third vertex;
computer usable program code configured to present a third line segment perpendicular to the line of symmetry and including first and second end points and a midpoint on the line of symmetry of the symmetrical body, wherein the third line segment is positioned between the first vertex and the second and third vertexes and wherein the third line segment has a length less than the predetermined width of the symmetrical body;
computer usable program code configured to present a fourth line segment connected between the first end point of the third line segment and the second vertex; and
computer usable program code configured to present a fifth line segment connected between the second end point of the third line segment and the third vertex.

19. The computer program product of claim 18, further comprising:
computer usable program code configured to present the predetermined length of the symmetrical body equal to the predetermined width; and
computer usable program code configured to present the third line segment of the symmetrical body about ⅔ of the predetermined length of the symmetrical body from the first vertex.

20. The computer program product of claim 18, further comprising computer usable program code configured to present the third line segment with the length about 2/10 less than the predetermined length of the symmetrical body.
